(19) United States
(12) Patent Application Publication
(10) Pub. No.: US 2011/0073382 A1
(43) Pub. Date: Mar. 31, 2011

(54) REMOTE CONTROLLER

(76) Inventor: Akira Miyazawa, Honjo-shi (JP)

(21) Appl. No.: 12/823,707

(22) Filed: Jun. 25, 2010

(30) Foreign Application Priority Data
Sep. 25, 2009 (JP) 2009-221051

(51) Int. Cl. G06F 3/041

(52) U.S. Cl. 178/18.03

(57) ABSTRACT

According to an aspect of the present invention, there is provided a remote controller including: a first touch pad having a first input face to be outwardly exposed; a second touch pad having a second input face to be outwardly exposed, the second input face being aligned with the first input face so that a sliding operation is continuously performed across the first input face and the second input face; and a first switch configured to be switched in accordance with a pressing operation applied onto the first touch pad.

### CROSS-REFERENCE TO RELATED APPLICATIONS

This application is based upon and claims the benefit of priority from Japanese Patent Application No. 2009-221051, filed on Sep. 25, 2009, the entire contents of which are incorporated herein by reference.

### BACKGROUND

1. Field

An aspect of the present invention relates to a remote controller.

2. Description of the Related Art

There is known a remote controller configured such that an operation-interface panel displayed on a video display apparatus is operated in accordance with the user's input operation that is applied to a touch pad disposed in the remote controller (for example, JP-2003-348371-A).

The remote controller disclosed in JP-2003-348371-A has: the touch pad which senses an operation position through a contact pressure of an user's finger; and an operation control portion which moves the selection position on the operation-interface panel when a sliding operation is performed based on the operation position on the touch pad, and which executes decision on the operation panel in accordance with the finger contact pressure applied onto the touch pad. Therefore, in the apparatus, the moving operation and decision operation on the operation-interface panel can be performed through the touch pad.

In the above-described remote controller, although the moving operation and decision operation on the operation-interface panel can be performed through the touch pad, the decision operation is sensed by a change in the finger pressure applied onto the touch pad. Therefore, the user cannot feel a pressing sensation, and it is hardly decided whether the decision operation succeeds or fails.

### BRIEF DESCRIPTION OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 illustrates an example video display apparatus in a first embodiment.

FIG. 2 illustrates an example block configuration of the video display apparatus.

FIG. 3 illustrates a example remote controller.

FIGS. 4A to 4C illustrate an example configuration of a touch pad switch, FIG. 4A being a plan view, FIGS. 4B and 4C being sectional views taken along line A-A.

FIG. 5 illustrates an example block configuration of a control system of the remote controller.

FIGS. 6A and 6B illustrate an example remote controller.

FIGS. 7A to 7C illustrate an example configuration of a touch pad switch in a second embodiment, FIG. 7A being a plan view, FIGS. 7B and 7C being sectional views respectively taken along lines C-C and D-D.

FIG. 8 illustrates an example block configuration example of a control system of the remote controller.

FIGS. 9A to 9C illustrate an example configuration of a touch pad switch in a third embodiment, FIG. 9A being a plan view, FIGS. 9B and 9C being sectional views respectively taken along lines E-E and F-F.

FIG. 10 illustrates an example block configuration of a control system of the remote controller.

### DETAILED DESCRIPTION

Various embodiments according to the present invention will be described hereinafter with reference to the accompanying drawings. In general, according to one embodiment of the present invention, there is provided a remote controller including: a first touch pad having a first input face to be outwardly exposed; a second touch pad having a second input face to be outwardly exposed, the second input face being aligned with the first input face so that a sliding operation is continuously performed across the first input face and the second input face; and a first switch configured to be switched in accordance with a pressing operation applied onto the first touch pad.

### First Embodiment

### Configuration of Video Display Apparatus

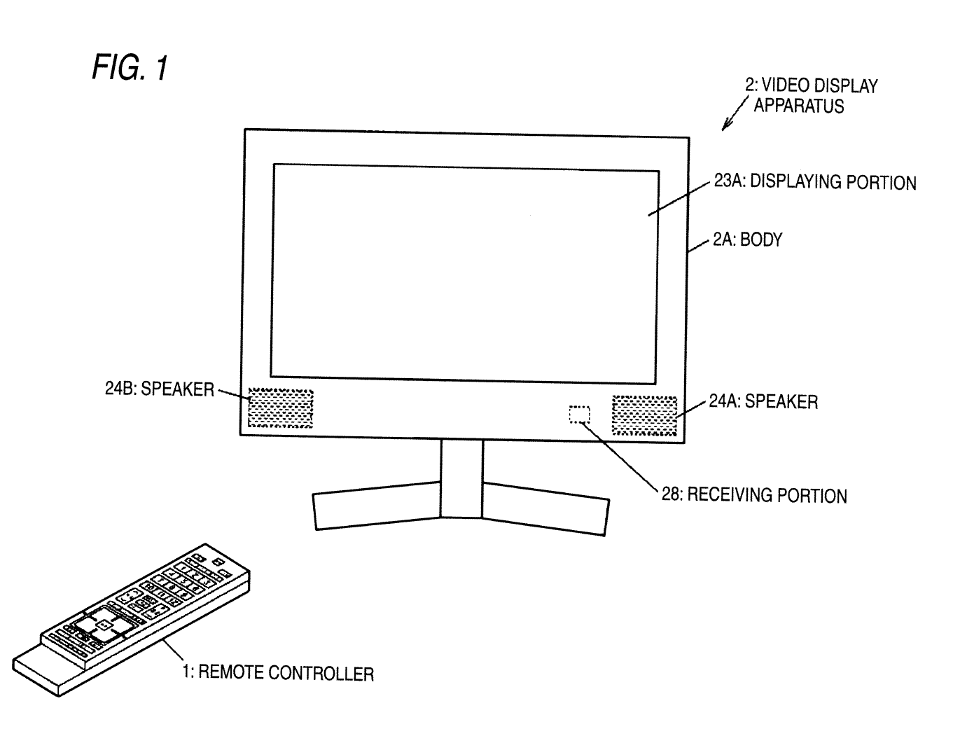

FIG. 1 illustrates a video display apparatus in a first embodiment

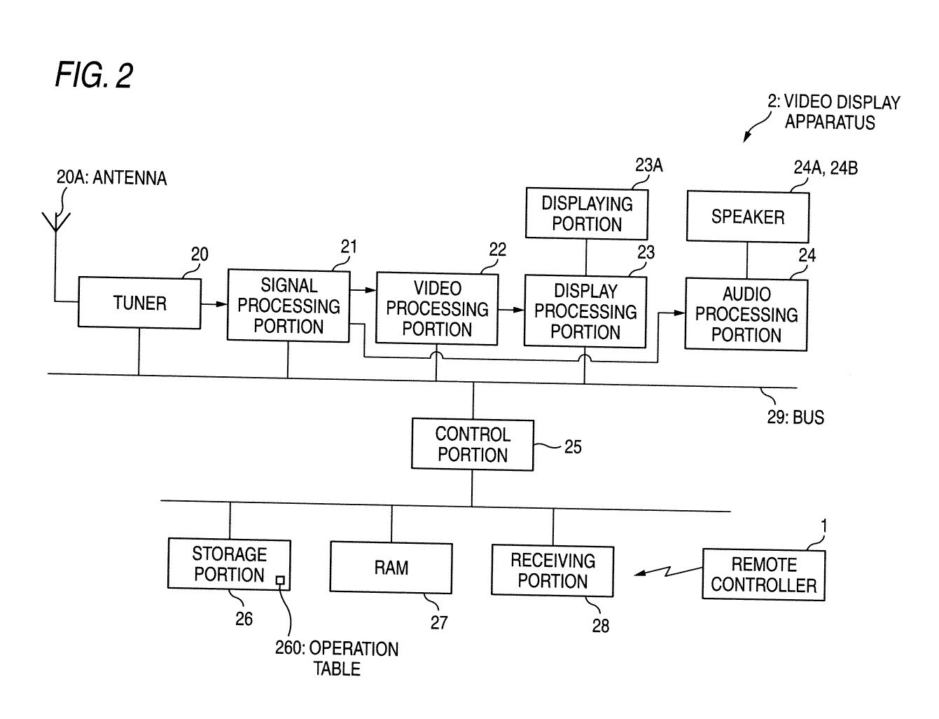

The video display apparatus 2 is a television receiver or the like which externally receives a digital broadcast wave or the like through an antenna (FIG. 2, 20A) to display a video image, or receives a video signal from an external video reproduction apparatus (not shown) such as an HDD (Hard Disc Drive) recorder or a DVD (Digital Versatile Disc) player to display a video image. The video display apparatus has: a displaying portion 23A configured by an LCD (Liquid Crystal Display) panel or the like in which a video image is displayed on the front face; speakers 24A, 24B which output a sound; and a receiving portion 28 which receives an operation signal using an RF (Radio Frequency) signal transmitted from a remote controller 1 having plural operation switches.

The video display apparatus 2 has, on the back face, an antenna terminal, external input terminals, operating portions configured by plural switches, and the like which are not shown, and, inside the body 2A, electronic components such as a CPU (Central Processing Unit) which processes the video signal and an audio signal, and which controls various portions, a RAM (Random Access Memory), a ROM (Read Only Memory), an HDD, etc.

The remote controller 1 has plural switches and touch pads, and, when an operation input is performed on one of them, transmits the operation signal for operating the functions of the video display apparatus 2, by using the RF signal.

FIG. 2 illustrates an example block configuration of the video display apparatus 2.

The video display apparatus 2 has a tuner 20, a signal processing portion 21, a video processing portion 22, a display processing portion 23, an audio processing portion 24, a control portion 25, a storage portion 26, a RAM 27, and a receiving portion 28. These portions are connected to one another through a bus 29.

The tuner 20 includes the antenna 20A which receives a broadcast signal transmitted from a digital broadcast station, selects a signal of a desired channel from the received broadcast signal, and transmits the selected signal to the signal processing portion 21.

The signal processing portion 21 is connected to the video processing portion 22 and the audio processing portion 24, separates the broadcast signal received from the tuner 20 to an audio signal and a video signal, supplies the video signal to the video processing portion 22, and supplies the audio signal to the audio processing portion 24.

The video processing portion 22 is connected to the displaying portion 23A through the display processing portion 23.

The display processing portion 23 performs an image quality adjustment on the input video signal, and supplies the video signal in which the image quality is adjusted, to the displaying portion 23A. The display processing portion 23 has a backlight processing portion, color temperature processing portion, and the like which are not shown, and which adjust the display condition of the displaying portion 23A. The displaying portion 23A has a backlight which is controlled by an inverter or the like to make the luminance variable, and the LCD panel which is illuminated by the backlight to display a video image. The backlight processing portion changes the luminance value of the backlight to adjust the brightness. The color temperature processing portion changes the gamma set value of the LCD panel to adjust the color temperature.

The audio processing portion 24 is connected to the speakers 24A, 24B. The audio processing portion 24 performs a sound quality adjustment on the input audio signal.

The video display apparatus 2 further has a video analog/digital converter (ADC) and audio ADC which receive video and audio signals transmitted from a video reproduction apparatus that is connected to an external input terminal (not shown). The video and audio signals which are input to the video ADC and the audio ADC are converted from an analog signal to a digital signal, and the output signals therefrom are supplied to the video processing portion 22 and the audio processing portion 24, respectively.

The control portion 25 controls the various portions through control lines which are indicated by the un-arrowed solid lines in FIG. 2.

The storage portion 26 stores an operation table 260 which correlates an operation input to the remote controller 1 with a control signal for controlling the various portions of the video display apparatus 2, video information of a program recorded by the video display apparatus 2, and the like.

The RAM 27 temporarily stores information to assist the operation of the control portion 25.

The receiving portion 28 receives the RF signal transmitted from the remote controller 1, and supplies the received signal to the control portion 25.

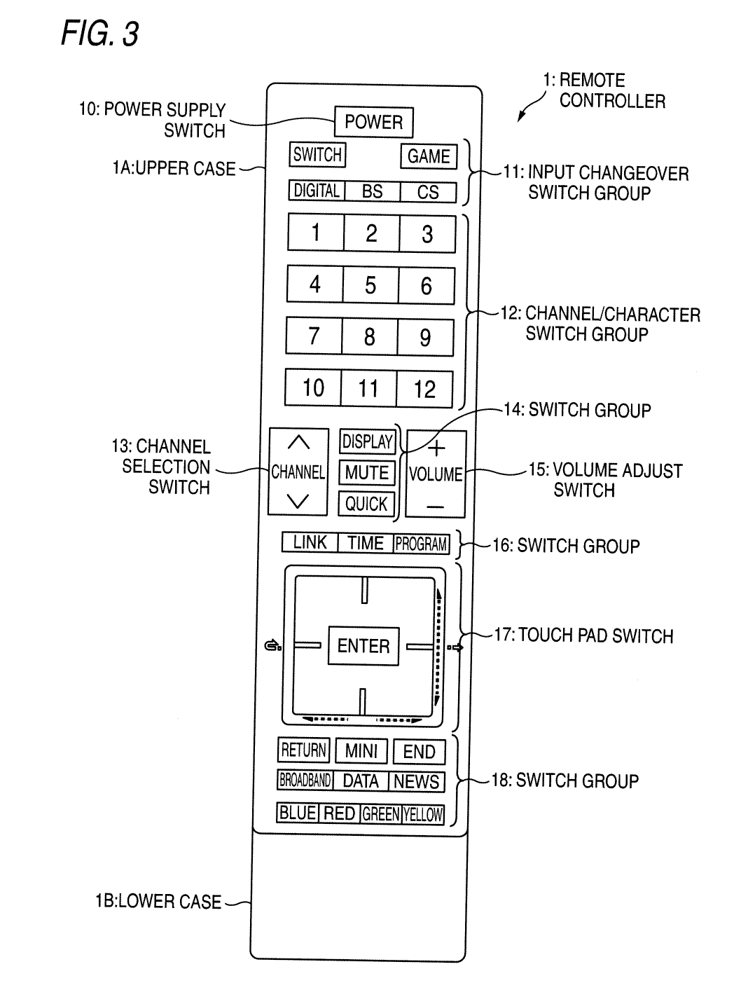

FIG. 3 exemplarily illustrates the remote controller 1.

The remote controller 1 is configured by an upper case 1A and a lower case 1B, and has plural switches for operating the functions of the video display apparatus 2. Specifically, the remote controller has: a power supply switch which switches over the power-ON state and the power-OFF state of the video display apparatus 2; an input changeover switch group 11 including an input changeover switch which switches over the source of video information to be displayed, and switches which select a game, a terrestrial digital broadcast, a BS broadcast, or a CS broadcast; a channel/character switch group 12 which performs selection of the channel, input of characters, and the like; a channel selection switch 13 which switches the channel; a switch group 14 including a screen display switch which selects the display format of the screen, a mute switch, a quick switch, and the like; a volume adjust switch 15 which adjusts the sound volume; a switch group 16 including a link switch which causes an external apparatus to link with the video display apparatus 2, a time switch for displaying a past program list, a program list switch for displaying a program list, and the like; a touch pad switch 17 which has both the function of a touch pad and the function of a press switch; and a switch group 18 which includes a return switch, a mini-program list switch, an end switch, a broadband switch, a d-data switch, a news switch, color switches, and the like.

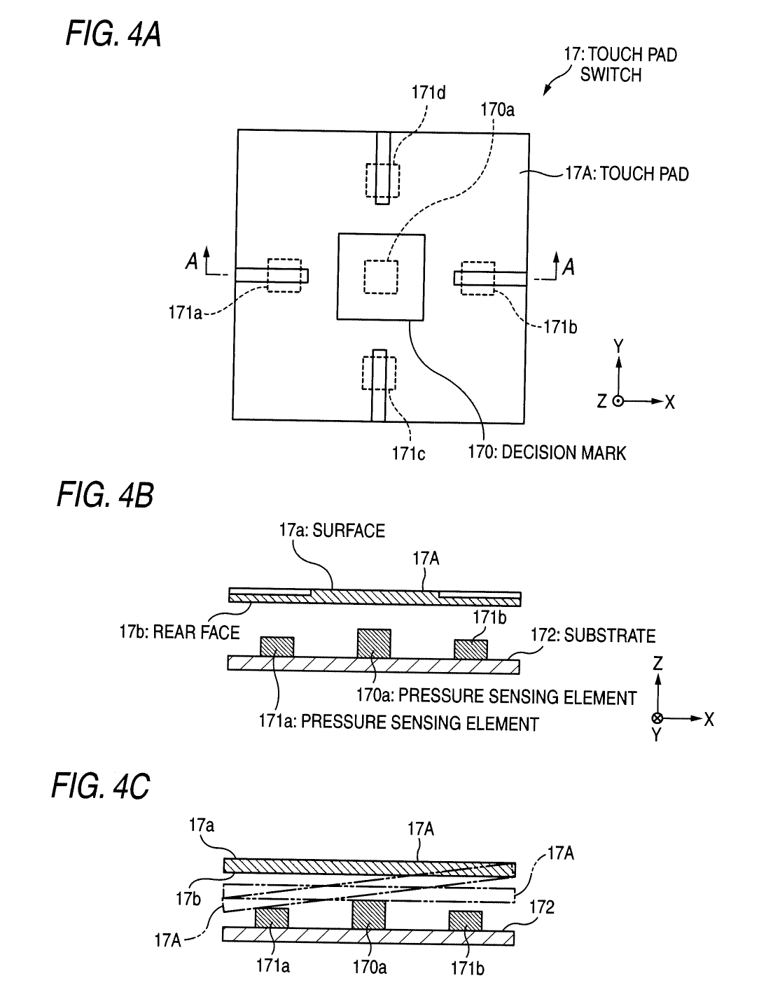

FIGS. 4A to 4C illustrate an example configuration of the touch pad switch 17, FIG. 4A is a plan view, and FIGS. 4B and 4C are sectional views taken along line A-A.

The touch pad switch 17 has: a substrate 172; a touch pad 17A which is supported by a supporting member (not shown) so as to down in the −Z-direction when the surface 17a is pressed by an user's finger or the like; and pressure sensing elements 170a and 171a to 171d each functioning as a switch which senses the pressure to output a sense signal when the rear face 17b of the touch pad 17A is contacted with the switch. A member which exerts a repulsive force, such as a spring is used as the supporting member, and supports the touch pad so that, when not operated, the rear face 17b is not contacted with the pressure sensing elements 170a and 171a to 171d.

The touch pad 17A senses a contact of an user's finger or the like with the surface 17a through, for example, a change in the electrostatic capacitance, and outputs operation positions in the X- and Y-directions as electric signals. The touch pad 17A includes plural X-direction electrodes along the X-direction, plural Y-direction electrodes along the Y-direction above the X-direction electrodes, and an insulating-material spacer interposed between the X-direction electrodes and Y-direction electrodes. When a finger or the like is contacted with the surface 17a of the touch pad 17A, the electrostatic capacitance between one of the X-direction electrodes and one of the Y-direction electrodes crossing at the contacting point changes, and an operation signal generation portion 100 converts the change in electrostatic capacitance to an electric signal.

The touch pad 17A is supported so that, when a portion of the surface 17a thereof is pressed, the pressure sensing elements 170a and 171a to 171d corresponding to the pressed portion in the Z-direction senses the pressure. When the portion of the surface 17a of the touch pad 17A corresponding to the pressure sensing element 171a is pressed, for example, the left half of the touch pad 17A downs in the −Z-direction as shown in FIG. 4C to attain the state indicated by the broken lines, and the rear face 17b is contacted with the pressure sensing element 171a. When the vicinity of a decision mark 170 is pressed, the whole touch pad 17A downs in the −Z-direction to attain the state indicated by the dash-dot-dot lines as shown in FIG. 4C, and the rear face 17b is contacted with the pressure sensing element 170a.

In each of the pressure sensing elements 170a and 171a to 171d, the resistance is reduced in accordance with the pressure caused when the element is pressed via the touch pad 17A, the resistance is converted to an electric signal, and the electric signal is output. In place of the pressure sensing elements 170a and 171a to 171d, electronic switches or mechanical switches may be used.

The touch pad switch 17 includes recesses on the surface 17a of the touch pad 17A at portions corresponding to the pressure sensing elements 170a and 171a to 171d in the Z-direction, so as to give a change in the tactile sensation to the user's finger tip, thereby presenting the operation position.

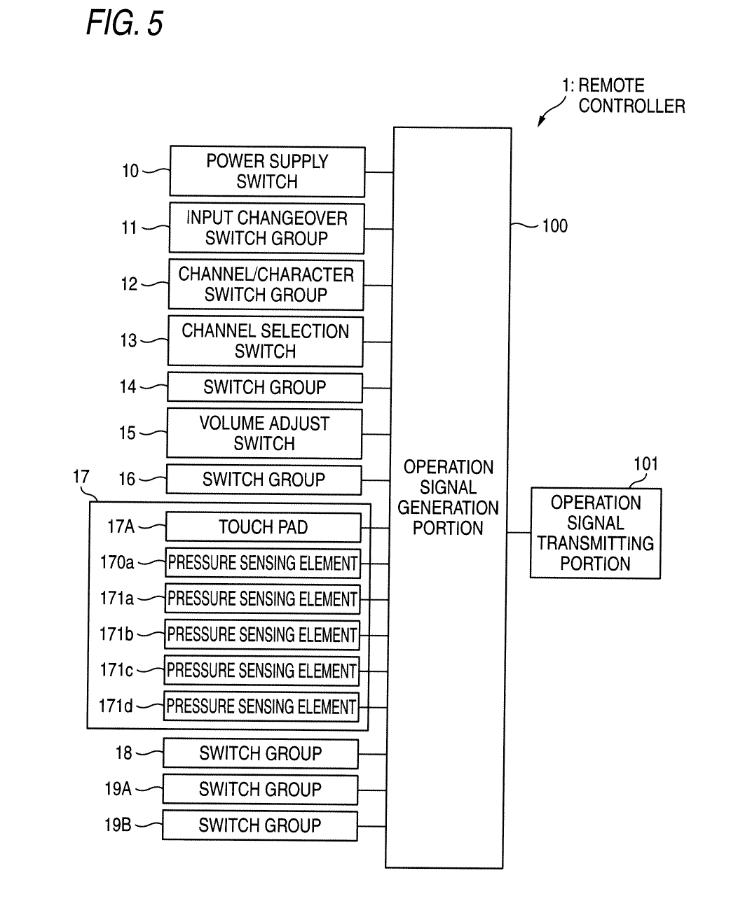

FIG. 5 illustrates an example block configuration of a control system of the remote controller 1.

The remote controller 1 has: the operation signal generation portion 100 which receives signals output from the power supply switch 10, the input changeover switch group 11, the channel/character switch group 12, the channel selection switch 13, the switch group 14, the volume adjust switch 15, the switch group 16, the touch pad switch 17, the switch group 18, and switch groups 19A, 198, and which generates operation signals respectively corresponding to the signals; and an operation signal transmitting portion 101 which converts the operation signals generated by the operation signal generation portion 100, to RF signals, and which transmits the RF signals to the video display apparatus 2.

The operation signal generation portion 100 supplies an electric power to the above-described switches through power supply lines which are not shown, and, when an operation input is not performed on the touch pad 17A for a given time period, suspends the power supply to the touch pad 17A. The power supply may be resumed in the following manner. When a menu screen or the like on which the touch pad 17A can be used is displayed in the video display apparatus 2, for example, the video display apparatus 2 may transmit a cancel signal by means of an RF signal to the remote controller 1. Alternatively, when a given operation is performed on the switches of the video display apparatus 2, e.g., when the touch pad switch 17 is pressed for a long time period, the suspension may be canceled.

In accordance with the user's setting, the operation signal generation portion 100 controls on/off of recognition of the sliding operation on the touch pad 17A. Namely, only the output signals of the pressure sensing elements 170a and 171a to 171d are deceived, and the output signal of the touch pad 17A is ignored. Or, the power supply to the touch pad 17A may be interrupted. Accordance with the user's setting, the operation signal generation portion 100 further controls the sensitivity of the sliding operation on the touch pad 17A. For example, the sensitivity of the touch pad 17A with respect to the sliding operation may be selected to be slow, standard, or fast.

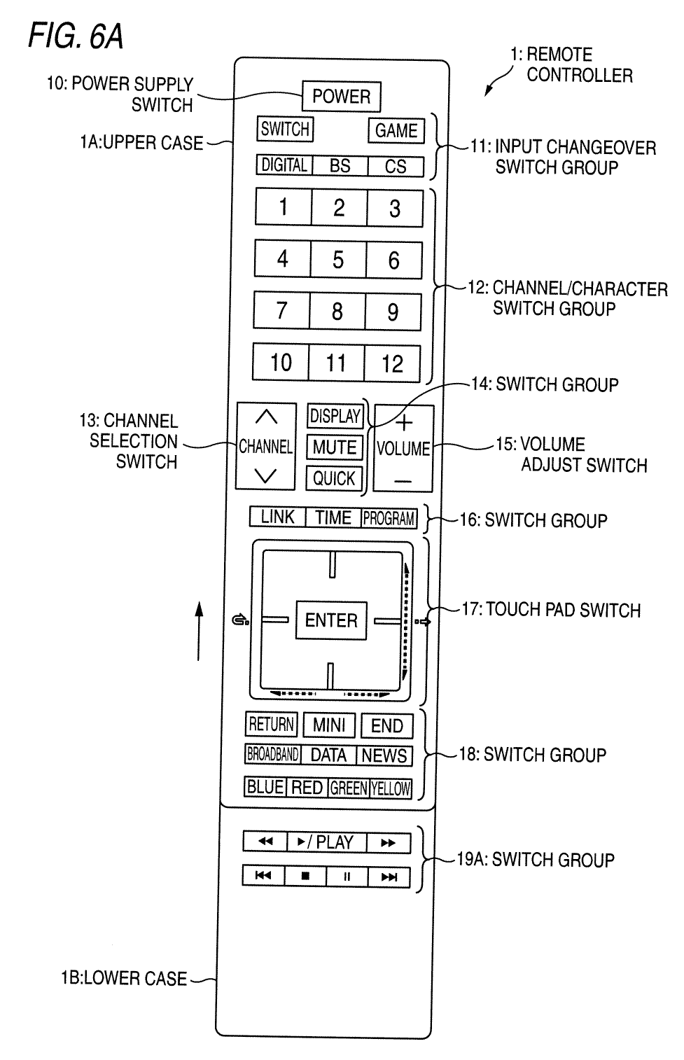

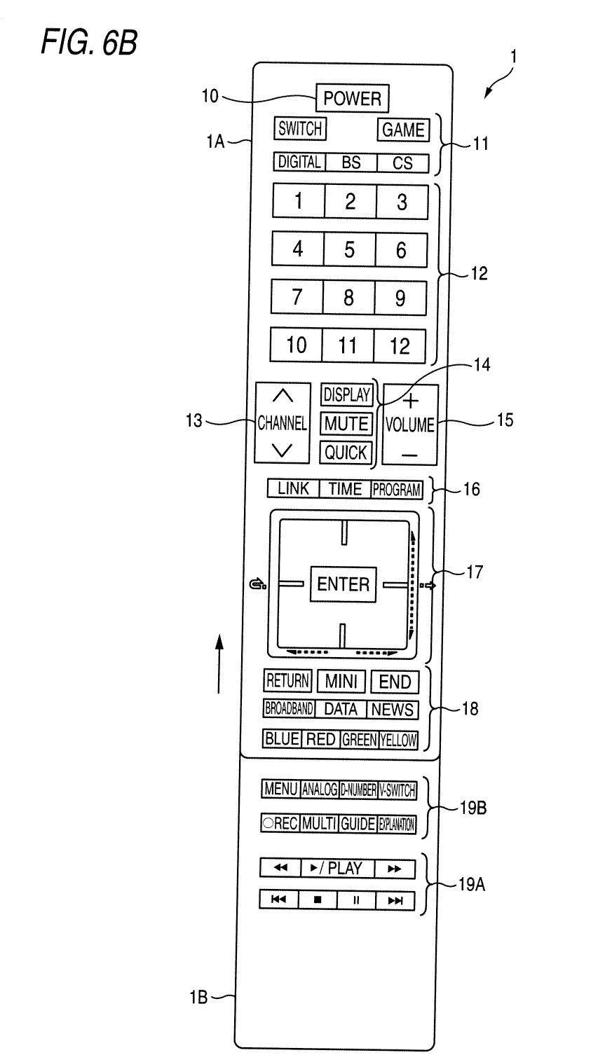

FIGS. 6A and 6B exemplarily illustrates the remote controller 1.

In the remote controller 1, the upper case 1A is attached to be movable in the vertical direction in the drawing with respect to the lower case 1B. For example, a set of a claw and groove may be provided on the sliding faces of the upper and lower cases 1A, 1B so that, when the upper case 1A is upwardly moved from the state shown in FIG. 3, the upper case 1A is stopped with respect to the lower case 1B at a position where the switch group 19A is exposed as shown in FIG. 6A.

The remote controller 1 is configured so that, when the upper case 1A is further upwardly moved from the state shown in FIG. 6A, the upper case 1A is stopped with respect to the lower case 1B at a position where the switch group 19B is exposed in addition to the switch group 19A as shown in FIG. 6B. As described above, the remote controller 1 of the embodiment is configured so that the upper case 1A is slid in two steps with respect to the lower case 1B.

Operation of Video Display Apparatus

Hereinafter, an operation example of the video display apparatus in the first embodiment will be described with reference to the figures.

In order to turn ON the power supply of the video display apparatus 2, first, the user presses the power supply switch 10 of the remote controller 1. When the power supply switch 10 is pressed, the operation signal generation portion 100 of the remote controller 1 generates an operation signal for turning ON the power supply of the video display apparatus 2. The operation signal transmitting portion 101 transmits the generated operation signal to the video display apparatus 2 by means of an RF signal. When the receiving portion 28 of the video display apparatus 2 receives the RF signal, the portion supplies an operation signal to the control portion 25, and, based on the received operation signal, the control portion 25 requests a power supplying portion (not shown) to turn ON the power supply of the video display apparatus 2.

Next, in accordance with the video image displayed on the displaying portion 23A of the video display apparatus 2, the user operates the switches of the remote controller 1. Hereinafter, the operation in accordance with the user's operation on the touch pad switch 17 will be described.

When the user presses the surface 17a of the touch pad 17A of the touch pad switch 17, among the pressure sensing elements 170a and 171a to 171d, the element corresponding to the pressed position outputs a sense signal to the operation signal generation portion 100, and the operation signal generation portion 100 generates an operation signal corresponding to the corresponding pressure sensing element. Next, the operation signal transmitting portion 101 transmits the generated operation signal to the video display apparatus 2 by means of an RF signal.

When the receiving portion 28 of the video display apparatus 2 receives the RF signal, the portion supplies an operation signal to the control portion 25. Based on the received operation signal, the control portion 25 refers the operation table 260, and, in accordance with the definition of the operation table 260, decides the operations of the respective portions in the video display apparatus 2. The operation table 260 may be defined so that the operations are changed in accordance with the video image displayed on the displaying portion 23A and the like.

For example, the pressing operation on the touch pad 17A may be correlated to the operation, such as a vertical/lateral movement of a selection display cursor displayed on the displaying portion 23A and a decision/cancel operation, in the video display apparatus 2.

When the user touches the surface 17a of the touch pad 17A of the touch pad switch 17 and performs a sliding operation by moving the contact position on the input face, the touch pad 17A supplies a sense signal to the operation signal generation portion 100, and the operation signal generation portion 100 generates an operation signal corresponding to the movement of the contact position. Next, the operation signal transmitting portion 101 transmits the generated operation signal to the video display apparatus 2 by means of an RF signal.

When the receiving portion 28 of the video display apparatus 2 receives the RF signal, the portion supplies an operation signal to the control portion 25. Based on the received operation signal, the control portion 25 refers the operation table 260, and, in accordance with the definition of the operation table 260, decides the operation in the video display apparatus 2.

For example, the sliding operation on the input face of the touch pad 17A may be correlated to operations, such as pointer free movement when displaying a web browser, a page changeover of when displaying a menu, and fast-forward or rewind in the video reproduction, in the video display apparatus 2.

### Effects of First Embodiment

According to the above-described embodiment, in the touch pad switch 17, a pressing operation to the touch pad 17A and an input to the input face on the touch pad 17A are enabled. Therefore, it is possible to provide the remote controller 1 which can provide the user with a decision operation having a pressing sensation, and in which a siding operation using the touch pad 17A is enabled.

In the remote controller, the switch groups 19A, 19B are exposed in a stepped manner by relative movement of the upper case 1A and the lower case 1B. The switch groups 19A, 19B may be placed in accordance with the use frequency or the like, and the use size of the remote controller 1 may be efficiently changed in accordance with its purpose.

The remote controller includes the recesses (marking patterns) on the surface 17a of the touch pad 17A at portions corresponding to the pressure sensing elements 170a and 171a to 171d in the Z-direction. The remote controller can give a change in the tactile sensation to the user's finger tip, so that, when the user performs a pressing operation, the use can easily know the operation position. In place of the recesses, projections or combinations of a recess and a projection may be used.

### Second Embodiment

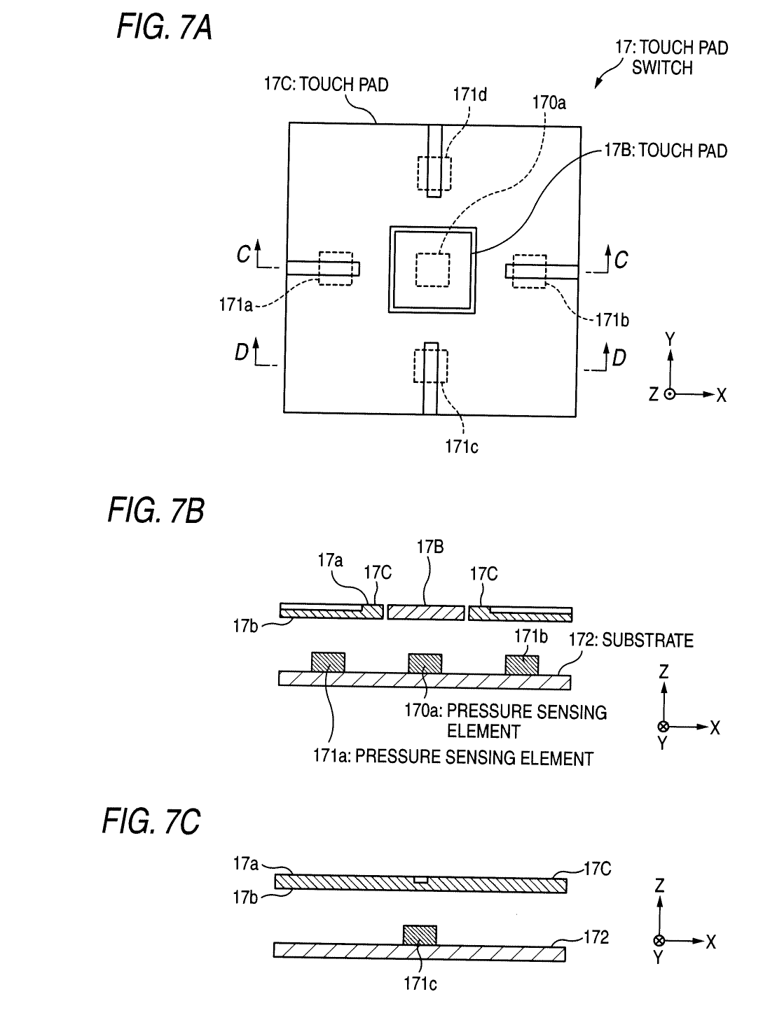

FIGS. 7A to 7C illustrate an example configuration of a touch pad switch 17 in a second embodiment, FIG. 7A is a plan view, and FIGS. 7B and 7C are sectional views respectively taken along lines C-C and D-D.

The touch pad switch 17 has: a substrate 172; two touch pads 17B, 17C which are supported by supporting members (not shown) so as to down in the −Z-direction when the surface 17a is pressed by an user's finger or the like; and pressure sensing elements 170a and 171a to 171d each functioning as a switch which senses the pressure output a sense signal when the rear face 17b of the touch pad 17B or 17C is contacted with the switch.

The touch pads 17B, 17C have functions of a decision key and cross operation key which are independent from each other, respectively, and are supported so that, when a portion of the surface 17a thereof is pressed, pressure sensing elements 170a and 171a to 171d corresponding to the pressed portion senses the pressure. When the portion of the surface 17a of the touch pad 17C of corresponding to the pressure sensing element 171a is pressed, for example, the left half of the touch pad 17A shown in FIG. 7A downs in the −Z-direction, and the rear face 17b is contacted with the pressure sensing element 171a. When the touch pad 17B is pressed, the whole touch pad 17B downs in the −Z-direction, and the rear face 17b is contacted with the pressure sensing element 170a.

The respective surfaces 17a of the touch pad 17B functioning as the decision button, and the touch pad 17C functioning as a cross key sense a contact of an user's finger or the like with the surface 17a through, for example, a change in the electrostatic capacitance, and output an operation position. An operation signal generation portion 100 is configured so that the surfaces 17a of the touch pads 17B, 17C continuously output the operation position in the boundary therebetween.

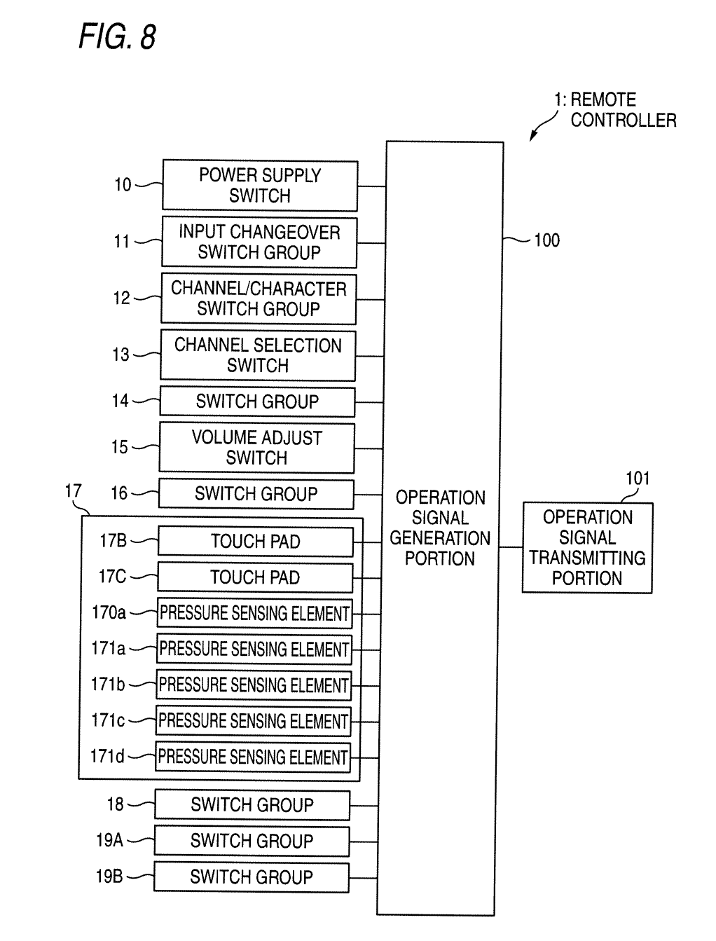

FIG. 8 illustrates an example block configuration of the remote controller 1.

The remote controller 1 includes the touch pads 17B, 17C as the touch pad switch 17, and the operation signal generation portion 100 continuously senses a sliding operation on the surfaces 17a of the touch pads 17B, 17C in the boundary therebetween. Namely, when an user's finger passes on the touch pad 17B from the left end to the right end of the touch pad 17C, for example, such movement is treated as a continuous movement from the left end to the right end of the surface 17a of the touch pad 17C.

### Effects of Second Embodiment

According to the above-described embodiment, in addition to the effects of the first embodiment, the touch pads 17B, 17C are separated from each other, and the touch pad 17B which is relatively smaller in area is allocated to the pressure sensing element 170a. Therefore, an operation of pressing the touch pad 17B functioning as the decision button can be performed more surely and easily.

Since the touch pad 17B is used as the decision button, not only the decision operation but also the sliding operation can be performed. And, a since sliding operation across the boundary of the touch pads 17B, 17C is treated as a continuous operation, a sliding operation can be performed using the whole surfaces 17a of the touch pad switch 17.

### Third Embodiment

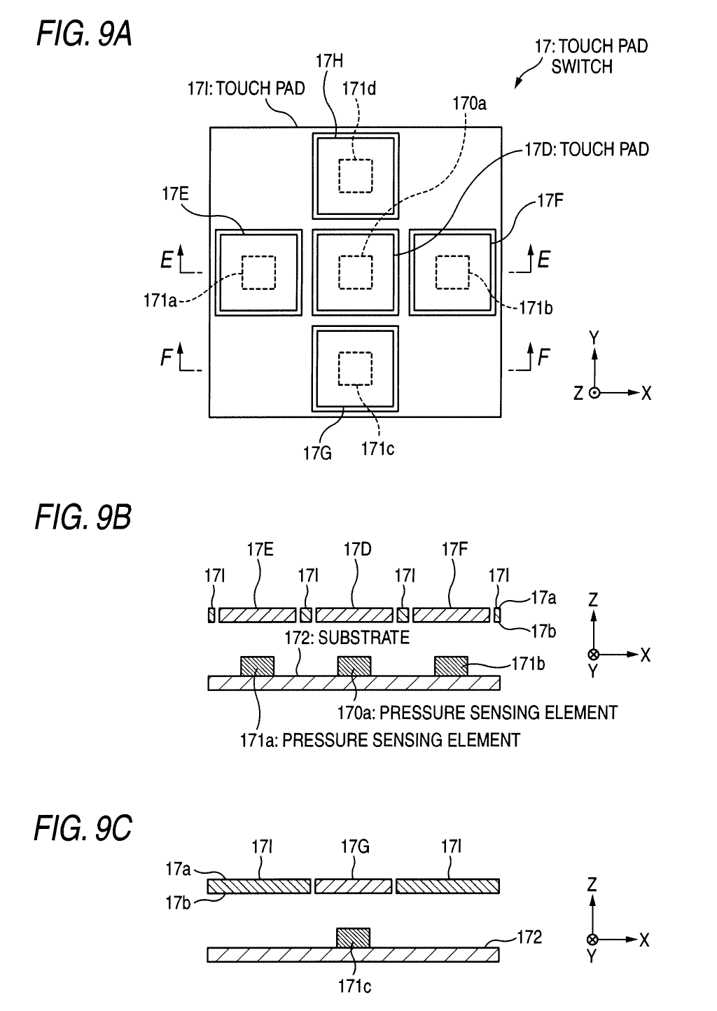

FIGS. 9A to 9C illustrate an example configuration of a touch pad switch 17 in a third embodiment, FIG. 9A is a plan view, and FIGS. 9B and 9C are sectional views respectively taken along lines E-E and F-F.

The touch pad switch 17 has: a substrate 172; five touch pads 17D to 17H which are supported by supporting members (not shown) so as to down in the −Z-direction when the surface 17a is pressed by an user's finger or the like; a touch pad 17I which is fixed so as not to down even when pressed; and pressure sensing elements 170a and 171a to 171d each functioning as a switch which senses the pressure to output a sense signal when the rear face 17b of one of the touch pads 17D to 17H is contacted with the switch. The respective surfaces 17a of the touch pads 17D to 17I sense a contact of an user's finger or the like through, for example, a change in the electrostatic capacitance, and output an operation position.

The touch pads 17D to 17H are supported so that, when one of the surfaces 17a is pressed, the corresponding one of the pressure sensing elements 170a and 171a to 171d senses the pressure. When the touch pad 17D is pressed, for example, the whole touch pad 17D downs in the −Z-direction, and the rear face 17b is contacted with the pressure sensing element 170a.

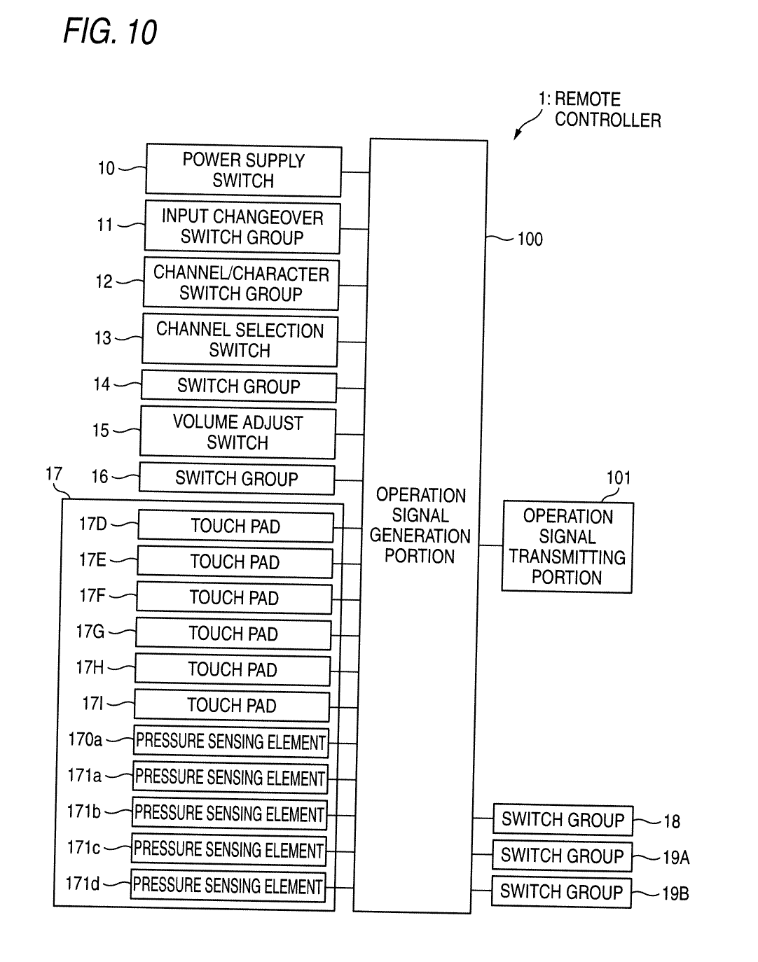

FIG. 10 illustrates an example block configuration of the remote controller 1.

The remote controller 1 includes the touch pads 17D to 17I as the touch pad switch 17, and the operation signal generation portion 100 continuously senses a sliding operation on the surfaces 17a of the touch pads 17D to 17I in the boundary therebetween. Namely, when an user's finger passes on the touch pads 17E, 17D, 17F from the left end to the right end of the touch pad 17I, for example, such movement is dealt as a continuous movement from the left end to the right end of the surface 17a of the touch pad 17I.

### Effects of Third Embodiment

According to the above-described embodiment, in addition to the effects of the second embodiment, the touch pads 17D and 17E to 17H each having a relatively-small area are allocated to the pressure sensing elements 170a and 171a to 171d, respectively. Therefore, a pressing operation to the touch pads 17D and 17E to 17H can be performed more surely and easily.

### Other Embodiments

The invention is not restricted to the above-described embodiments, and can be variously modified without departing the spirit of the invention. For example, the division number and shape of the touch pads of the touch pad switch 17 are not restricted. The number and placement of the pressure sensing elements may be appropriately changed in accordance with those of the touch pads.

Furthermore, the rear face 17b of the touch pad 17A may be indirectly contacted with the pressure sensing elements 170a and 171a to 171d through members or the like. Non-contact switches may be used in place of the pressure sensing elements.

According to an aspect of the invention, there is provided a remote controller which can provide the user with a sliding operation and a decision operation having a pressing sensation.

What is claimed is:

1. A remote controller comprising:
a first touch pad having a first input face to be outwardly exposed;
a second touch pad having a second input face to be outwardly exposed, the second input face being aligned with the first input face so that a sliding operation is continuously performed across the first input face and the second input face; and
a first switch configured to be switched in accordance with a pressing operation applied onto the first touch pad.

2. The remote controller of claim 1,
wherein the second touch pad is configured so that the second input face surrounds the first input face.

3. The remote controller of claim 1, further comprising:
a second switch configured to be switched in accordance with a pressing operation applied onto the second touch pad.

4. The remote controller of claim 3,
wherein the second touch pad includes a marking pattern configured by a recess, a projection, or a combination of a recess and a projection on the second input face thereof, and
wherein the marking pattern is formed at a position where the pressing operation to switch the second switch is to be applied.

5. A remote controller comprising:
a touch pad having an input face to be outwardly exposed, a decision region being defined around a middle of the input face; and
a plurality of switches configured to be switched in accordance with a pressing operation applied onto the decision region of the input face and with a pressing operation applied onto a region of the input face other than the decision region, respectively.
